(19) United States
(12) Patent Application Publication
(10) Pub. No.: US 2019/0084798 A1
(43) Pub. Date: Mar. 21, 2019

(54) METHOD FOR OPERATING A LIFT SYSTEM, CONTROL SYSTEM, AND LIFT SYSTEM

(71) Applicants: THYSSENKRUPP ELEVATOR AG, Essen (DE); thyssenkrupp AG, Essen (DE)

(72) Inventors: Jörg MÜLLER, Deizisau (DE); Stefan GERSTENMEYER, Filderstadt (DE); Bernd ALTENBURGER, Neuhausen (DE)

(73) Assignees: THYSSENKRUPP ELEVATOR AG, Essen (DE); thyssenkrupp AG, Essen (DE)

(21) Appl. No.: 15/742,928

(22) PCT Filed: Jul. 7, 2016
(86) PCT No.: PCT/EP2016/066161

§ 371 Date: Jan. 9, 2018

(30) Foreign Application Priority Data
Jul. 9, 2015 (DE) 10 2015 212 882.2

(51) Int. Cl. B66B 5/00; B66B 1/24

(52) U.S. Cl. CPC B66B 5/0031; B66B 5/0012; B66B 2201/103; B66B 5/0037; B66B 1/2433

(57) ABSTRACT

A method for operating an elevator installation may be used with elevator installations that have at least two cars in one elevator shaft. A first car may be travelling or configured to travel in a direction of a second car, and the first car may be moved with reference to a travel curve in such a way that a distance between the first car and the second car can be controlled to an adjustable minimum distance. The adjustable minimum distance may be set as a function of a speed of at least one of the first car or the second car. Further, the distance between the first car and the second car can be controlled to the adjustable minimum distance with continuous calculation of a virtual stopping point for the first car, at which virtual stopping point the first car is stoppable with a safety clearance from the second car.

The present invention relates to a method for operating an elevator installation comprising at least two cars in one elevator shaft, a control system for such an elevator installation, and such an elevator installation.

### PRIOR ART

In elevator systems with two or more cars in one elevator shaft, so-called multi-car systems, paths for the cars in the elevator shaft are not always free without restriction. Attention must, for example, be paid to safety clearances, so that an emergency stop is not initiated, for example through an emergency halt or emergency braking of the car, as can be induced, for example, in the context of preventing a collision.

It can therefore be provided that a car is not allowed to move away from its stationary location until it can reach its destination directly and with a normal travel, i.e. with the travel parameters of speed, acceleration and jerk having their rated values. This means that when a second car is directly in the path of the first car, the first car is held back for a certain time so that waiting times in the car can arise for passengers until the second car has freed the path to the destination. The waiting times also occur if the first, waiting car would catch up the second, slower car that is moving in the same direction. If the elevator does not start normally or immediately, the waiting time can cause irritation to the passengers.

A method for operating an elevator system with a plurality of cars in one elevator shaft is known, for example, from U.S. Pat. No. 7,819,228 B2, in which a collision probability of two cars is continuously determined and, if necessary, the speed or the acceleration/deceleration of one or both of the cars is changed, or even an unplanned stop is made.

A control system for an elevator system with a plurality of cars in one elevator shaft is known, for example, from U.S. Pat. No. 6,273,217 B1, in which a possible collision of the cars is determined on the basis of the predicted arrival times of two cars at their respective destination stories and one car is, if necessary, halted.

In the case of an elevator system with at least two cars in one elevator shaft it is therefore desirable to provide a possibility for conveying as many passengers as possible more quickly and without irritation.

### DISCLOSURE OF THE INVENTION

According to the invention, a method for operating an elevator installation, a control system, and an elevator installation with the features of the independent claims is proposed. Advantageous embodiments are objects of the dependent claims and of the following description.

A method according to the invention is used for operating an elevator installation with at least two cars in one elevator shaft. A first car, which is moving or is meant to move in the direction of a second car, is moved here with reference to a travel curve in such a way that a distance between the first car and the second car can be controlled to an adjustable minimum distance.

This can be achieved, for example, through a deviation from a conventional travel curve in which the rated parameters of, for example, speed and acceleration, are specified. For example, the first car, which is meant to travel behind the second car, can already start moving when all the passengers have entered and the car is ready to move, even if a conventional travel with rated parameters would not yet be possible because, for example, the second car is still too close to the first car. Disturbing waiting times before the car starts moving are thus avoided. The travel parameters such as speed and acceleration can here be appropriately modified. By controlling the distance between the two cars to a minimum distance, it is ensured that no dangerous situations can occur, such as, for example, a collision between the cars in the event of an unexpected emergency halt of the second, leading car. Through the distance control, the first, trailing car can react optimally to the travel of the second, leading car. The fastest possible achievement of the destination story by the first car is enabled in this way. In particular, by controlling to a minimum distance, this minimum distance can be deliberately approached. In the context of the control process, the minimum distance can be taken into account right at the start of the travel, whereas, in contrast, a reaction such as, for example, a sharp braking that only occurs when a certain distance is undershot, can, for example, result in an unwanted jerk that is perceived by passengers.

It is clear that this method can also be applied when there are more than two cars in one elevator shaft, in that it is applied to each two neighboring cars. This can accordingly also mean that the travel curve of one car is dependent on a plurality of leading cars.

In particular, a method for operating an elevator installation comprising at least two cars in one elevator shaft is proposed, wherein a first car, which is travelling or is meant to travel in the direction of a second car, is moved with reference to a travel curve wherein an adjustable minimum distance between the first car and the second car is maintained at all times, and wherein the first car is moved with reference to the travel curve in such a way that a distance between the first car and the second car is controlled when moving the first car to the adjustable minimum distance, so that the first car can deliberately approach this minimum distance from the second car.

Preferably the minimum distance is set depending on a speed of the first car and/or of the second car. Allowance can be made in this way for a greater braking distance at greater speed.

Advantageously the distance between the first car and the second car is controlled to the minimum distance with continuous calculation of a virtual stopping point for the first car, at which the first car can be stopped with a safety clearance from the second car. The minimum distance between the two cars can be kept very small through such a determination or calculation of a virtual stopping point. The virtual stopping point can, for example, always be chosen such that the first car would come to a halt with a safety clearance from the current position of the second car.

It is advantageous if a braking distance of the second car is taken into account in the determination of the virtual stopping point. The minimum distance can be further reduced in this way, since the distance that would be covered by the second car between a hypothetical start of braking and end of braking of the first car is taken into account.

Preferably the braking distance of the second car is determined in accordance with an emergency halt or with a controlled emergency deceleration of the second car and/or a loading of the second car. This allows a determination of the braking distance of the second car that is as accurate as possible, while at the same time maintaining a necessary safety clearance between the two cars following a hypothetical stop of both cars.

It is advantageous if the travel curve of the first car is specified and/or set as a function of a travel curve of the second car. A particularly precise control is possible in this way. It is, for example, possible in this way to react at an early stage to possible changes to be expected in the speed of the leading car.

In an approach of the first and second cars, if the two are at most a predetermined number of stories apart it is advantageous for the first car to be accelerated with a lower acceleration than the second car. This permits a simultaneous, or at least substantially simultaneous departure of the two cars while at the same time taking the minimum distance, which increases as the speed becomes greater, into account. Waiting times for passengers are avoided in this way. The number of stories can here be specified according, for example, to the building in which the elevator installation is located and according to the possible acceleration and speed of the cars. Two to four stories can, in particular, be specified as the number of stories.

During an approach, it is advantageous if the first car is moved using a maximum available or permissible acceleration in such a way that the minimum distance between the first car and the second car is achieved as quickly as possible. In this way the first car drives, so to speak, as quickly as possible up to the second car, until the minimum distance is reached. Travel times can be minimized in this way.

Preferably a speed, an acceleration, a deceleration and/or a jerk of the first car is or are specified by the travel curve. In this way an optimum travel curve can be calculated, for example continuously, and the said initial magnitudes can be supplied directly to an elevator controller or to a part thereof that is used for control of the drive.

Advantageously the speed, the acceleration, the deceleration and/or the jerk of the first car are each limited by maximum and/or minimum values. It is possible in this way, for example, on the one hand for a safety-related limit to be maintained and on the other hand for energy to be saved. In addition, in particular through specifications for the jerk, i.e. the change of the acceleration over time, it is possible for driving situations that are uncomfortable for passengers to be avoided.

In a travel in which the speed, the acceleration, the deceleration and/or the jerk of the first car deviate from the maximum or rated values, it is preferable for passengers in the first car to be visually and/or acoustically informed about the respective deviation. Appropriate display and/or acoustic means can, for example, be provided for this purpose. It is possible in this way for potential insecurities on the part of the passengers resulting, for example, from a speed that is lower than usual, to be avoided.

It is advantageous if the distance between the first car and the second car is determined by means of a position determination system of the two cars. Since such position determination systems, such as, for example, simple markings in the elevator shaft with corresponding sensors on the cars, are usually present in any case in elevator systems, this permits a particularly simple execution of the proposed method.

A method according to the invention can also be used in an elevator system with a plurality of elevator shafts. The method can be used there for every elevator shaft in which at least two cars are present.

A control system according to the invention for an elevator installation with at least two cars in one elevator shaft is designed to carry out a method according to the invention.

An elevator installation according to the invention comprises at least two cars in one elevator shaft and a control system according to the invention.

For the avoidance of repetitions, we refer to the above explanations for the advantages of the control system according to the invention and of the elevator installation according to the invention.

Further advantages and embodiments of the invention emerge from the description and the attached drawing.

It is obvious that the characteristics quoted above and those still to be explained below can be used not only in the combination given in each case, but also in other combinations, or alone, without leaving the framework of the present invention.

The invention is illustrated schematically in terms of an exemplary embodiment in the drawing, and is described below with reference to the drawing.

### DESCRIPTION OF THE FIGURES

FIG. 1 shows schematically an elevator shaft of an elevator installation according to the invention in a preferred form of embodiment with two cars.

FIG. 2 shows, in a diagram, travel curves of two cars in one elevator shaft in the case of a method not according to the invention.

FIG. 3 shows, in a diagram, further travel curves of two cars in one elevator shaft in the case of a method not according to the invention.

FIG. 4 shows schematically a distance control between two cars in one elevator shaft in a method according to the invention in a preferred form of embodiment.

FIG. 5 shows schematically a distance control between two cars in one elevator shaft in the case of the method according to the invention in a further preferred form of embodiment.

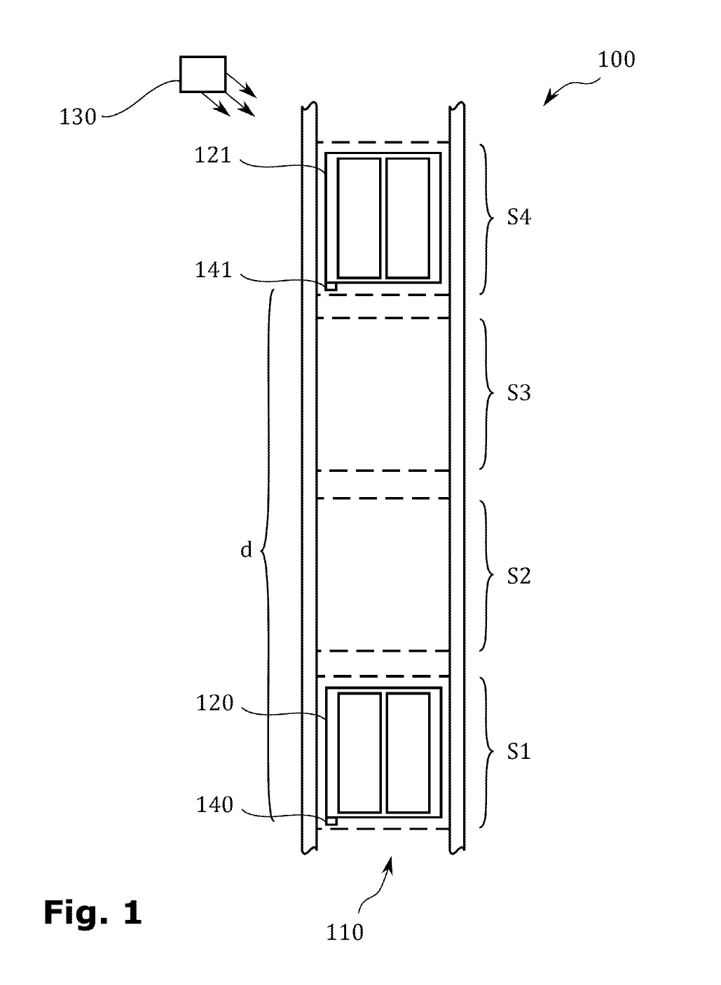

FIG. 1 shows schematically a cross-section of an elevator shaft of an elevator installation 100 according to the invention in a preferred form of embodiment. Two cars are shown by way of example in the elevator shaft 110, a first car 120 and a second car 121.

Four stories S1, S2, S3 and S4 are also shown schematically in the illustrated section of the elevator shaft 110 by way of example. The first car 120 is located at the level of story S1, and the second car 121 at the level of story S4.

A sensor is, furthermore, provided on the respective underside of each car, a first sensor 140 at the first car 120 and a second sensor 141 at the second car 121. The position of each of the two cars 120, 121 in the elevator shaft 110 can be determined by means of the sensors 140, 141, for example through scanning or reading markings or absolutely encoded strips, for example on an inner wall or a rail in the elevator shaft.

A distance d between the first car 120 and the second car 121 can now be determined using the sensors 140, 141 in the manner of position determination systems. The distance din the present figures is defined as a distance between the two sensors or as a distance between the undersides of the two cars. It is however obvious that the distanced can also be specified in another manner, for example as the distance between the underside of the upper car and the upper side of the lower car. Converting between these is easy if the dimensions of the cars are considered.

It is furthermore obvious that the illustrated position determination systems using the sensors 140, 141 to determine the distance between the two cars is purely by way of example. Other suitable position determination systems can equally be used. Advantageously, whatever position determination systems are in any case present in an elevator installation are used.

A control system 130, for example in the form of a computing unit, is furthermore provided, and is configured to control the elevator installation 100, i.e. to move the cars 120 and 121. The control system 130 is, furthermore, configured to carry out a method according to the invention, which is explained below in more detail.

In FIG. 2, travel curves 125 and 126 of two cars, 120 and 121 respectively, in one elevator shaft are shown on a diagram for a method not according to the invention. The travel curves 125, 126 are here illustrated as height h in the elevator shaft against time t. A speed of the cars can here be easily recognized in the gradient of the travel curves. The travel curves follow, for example, setpoint values of a travel curve computer (setpoint generator), which is, for example, provided in the control system 130. The setpoint values here are in particular the speed (or a speed of rotation of a motor in an elevator drive), but also the acceleration and the jerk of the cars.

The first car 120 is initially situated at height h₁ and the second car 121 at height h₂. These heights can, in particular, correspond to starting stories. The second, upper car 121 starts at time t₁ from height h₂ and is moved according to the travel curve 126 to height h₄, which can, in particular, correspond to a destination story of the second car 121.

The first, lower car 120 starts at time t₂ from height h₁ and is moved according to the travel curve 125 to height h₃, which can, in particular, correspond to a destination story of the first car 120. In the illustrated figure, both travel curves 125 and 126 correspond to travel curves using rated values for speed, acceleration and jerk for the respective cars with the respective starting and destination stories.

The time difference between the starting times t₁ and t₂ results from a period of time in which information that the second car 121 has started moving has reached the first car 121. In practice, this can, for example, involve only a few milliseconds, so that the two cars essentially start off simultaneously. A larger time difference can, for example, arise if a car door can not yet be closed, because, for example, a person is standing in the region of the car door.

It should be noted here that the distance between the two cars 120 and 121, which corresponds to the vertical distance of the two travel curves 125 and 126, is relatively constant in the illustrated example. In particular, it never undershoots a minimum distance, which ensures that if the second, upper car 121 stops unexpectedly, the first, lower car 120 can be halted without colliding with the second car.

Thus, in other words, if the destination story is guaranteed to be reached by the first, lower car 120 with normal travel, i.e. with a travel curve using rated values, a normal travel is started for the first car. In this case, “guarantee” means that the second car 121 is either sufficiently far away and is not located in the path of the first car 120 to the destination story, and also does not want to move into the path of the first car 120, or that the second car 121 is about to leave the path of the first car 120 in a safe stopping location, and the first car 120, which is starting, will not in normal travel undershoot the minimum distance required for the respective travel speed during the travel to its destination story.

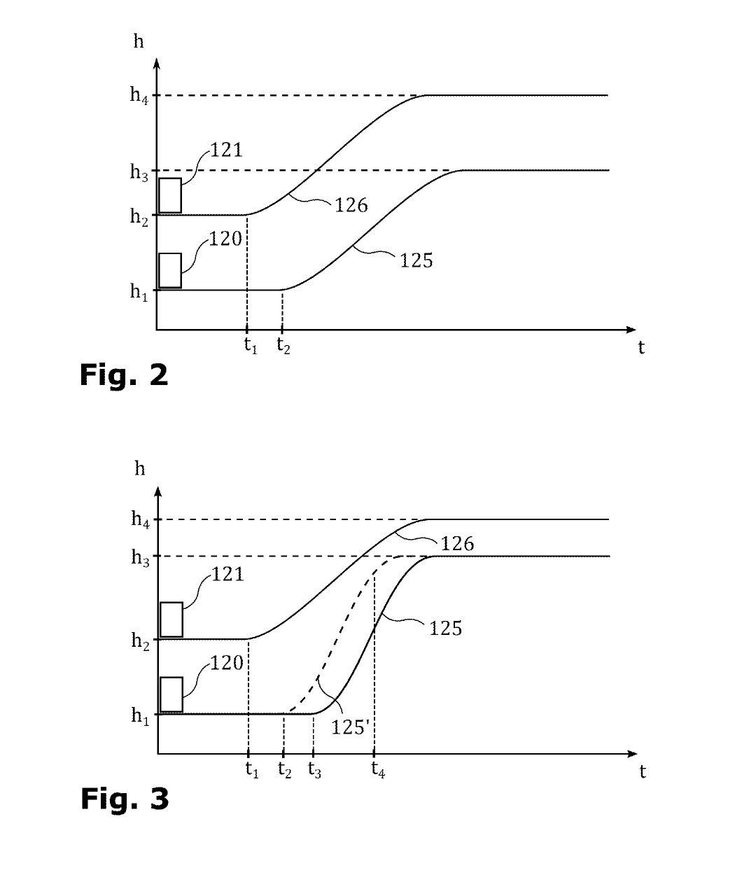

In FIG. 3, further travel curves 125 and 126 of two cars 120 and 121 respectively, in one elevator shaft are shown on a diagram for a method not according to the invention. In contrast to FIG. 2, a destination story for the first, lower car 120 is positioned further above the starting story of the second, upper car, i.e. the difference between height h₂ and height h₃ is larger in comparison with the example shown in FIG. 2. The destination story of the second car, i.e. the height h₄, is, however, unchanged. The difference between the two destination stories, or between the two heights h₃ and h₄, is thus less than in FIG. 2.

If the first car 120, again as in the example of FIG. 2, were to start at time t₂, and were to follow the dashed travel curve 125′ with the associated rated values, a very small distance would result between the two cars, which would undershoot a minimum distance as was defined above (c.f. for example time t₄). The time at which the first car 120 starts is therefore delayed until time t₃. The first car 120 will thus accordingly move on travel curve 125, which has the same rated values as travel curve 125′, but is delayed in time. The minimum distance between the two cars will thus be maintained at all times during the travel.

Passengers in the first car 120 can, however, experience such a delayed start as disturbing and uncomfortable, in particular if they are already in the car.

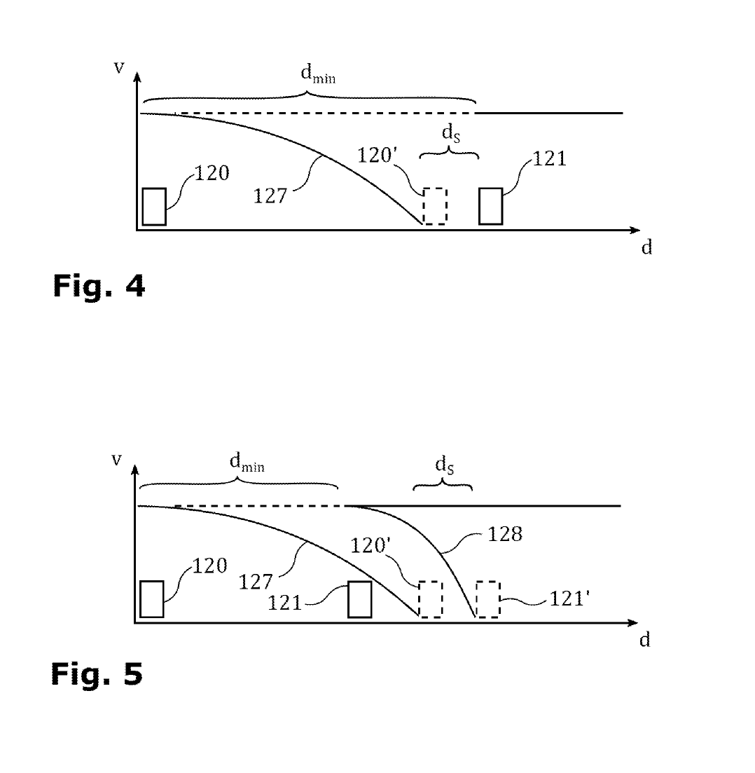

A distance control between two cars 120 and 121 in one elevator shaft in a method according to the invention is shown schematically in FIG. 4 in a preferred form of embodiment. The first car 120 and the second car 121 are illustrated for this purpose with their positions at an arbitrary point in time.

The distance d between the two cars is here controlled to a minimum distance dₘᵢₙ. This minimum distance dₘᵢₙ, is here specified such that if the first car 120 is braked after the said point in time, it would still come to a halt at the said point in time with a safety clearance ds from the position of the second car 121. This hypothetical or virtual stopping point is illustrated in the figure by the position of the car 120′.

This position of the car 120′, i.e. the virtual stopping point, can be determined at the said point in time on the basis of the speed curve 127 of the first car 120. This speed curve 127 is, for example, given on the basis of the current speed and of an emergency halt or emergency braking that starts at the said point in time.

By means of calculating the virtual, possible stopping point 120′ of the trailing car, the speed of the trailing car is adjusted such that the car is able to stop at this stopping point. The values for the speed, deceleration and jerk are limited to the rated or maximum values.

A lower limit can also be specified using minimum values. The values for the deceleration (including jerk) can correspond here to the rated parameters.

A distance control between two cars 120 and 121 in one elevator shaft in a method according to the invention is shown schematically in FIG. 5 in a further preferred form of embodiment. The first car 120 and the second car 121 are illustrated for this purpose with their positions at an arbitrary point in time.

The distance d between the two cars is here controlled to a minimum distance dₘᵢₙ. This minimum distance dₘᵢₙ is here specified such that if the first car 120 is braked after the said point in time, it would still come to a halt with a safety clearance ds from the position of the second car 121 which this would have at the time when the first car 120 comes to a halt (illustrated by the car 121′). This hypothetical or virtual stopping point is illustrated in the figure by the position of the car 120′.

This position of the car 120′, i.e. the virtual stopping point, can be determined at the said point in time on the basis of the speed curve 127 of the first car 120 and of the speed curve 128 of the second car 121.

Cars that are positioned close to one another can thus start simultaneously, or shortly after one another, through a method according to the invention. The subsequent car is thus (as a result) started with a smaller resulting acceleration than the leading car, so that the distance will increase with increasing speed. Reduced acceleration and jerk also reduce wear and energy consumption in the elevator installation, as well as the stress on the passengers.

This means, furthermore, that the trailing car can also approach the leading car more quickly, to then adjust its speed in order to then follow the leading car at a controlled distance.

The passengers in the car can be informed, for example using suitable visual and/or acoustic means, of travels that deviate from a usual, normal travel at rated values. Information can, for example, be a remaining travel time to the next stop, the value of the speed of travel as a percentage of normal speed, speed adjustment during the travel, or the type of travel (e.g. tracking travel).

1.-14. (canceled)

15. A method for operating an elevator installation that includes a first car and a second car in an elevator shaft, the method comprising:
moving the first car with reference to a travel curve, wherein the first car is traveling or is configured to travel in a direction of the second car; and
maintaining an adjustable minimum distance between the first car and the second car,
wherein the first car is moved with reference to the travel curve such that a distance between the first car and the second car is controlled when moving the first car to the adjustable minimum distance so that the first car can approach the adjustable minimum distance from the second car.

16. The method of claim 15 wherein the adjustable minimum distance is set as a function of a speed of at least one of the first car or the second car.

17. The method of claim 15 wherein the distance between the first car and the second car is controlled to the adjustable minimum distance with continuous calculation of a virtual stopping point for the first car, at which virtual stopping point the first car is stoppable with a safety clearance from the second car.

18. The method of claim 17 wherein the continuous calculation of the virtual stopping point for the first car is based at least in part on a braking distance of the second car.

19. The method of claim 18 wherein the braking distance of the second car is determined in accordance with at least one of an emergency halt of the second car, a controlled emergency deceleration of the second car, or a loading of the second car.

20. The method of claim 15 wherein the travel curve of the first car is specified or set as a function of a travel curve of the second car.

21. The method of claim 15 wherein if the first and second cars are at most a predetermined number of stories apart as the first and second cars approach one another, the method comprises accelerating the first car with a lower acceleration than the second car.

22. The method of claim 15 comprising moving the first car with a maximum available acceleration or a maximum permissible acceleration to achieve the adjustable minimum distance between the first and second cars as quick as possible.

23. The method of claim 15 wherein at least one of a speed, an acceleration, a deceleration, or a jerk of the first car is specified by the travel curve.

24. The method of claim 23 wherein the at least one of the speed, the acceleration, the deceleration, or the jerk of the first car is limited by at least one of a maximum value or a minimum value.

25. The method of claim 24 wherein if the at least one of the speed, the acceleration, the deceleration, or the jerk of the first car deviates from the at least one of the maximum value or the minimum value, the method comprises informing passengers in the first car at least one of visually or acoustically about the deviation.

26. The method of claim 15 comprising determining the distance between the first car and the second car by way of a position determination system.

27. A control system for an elevator installation that includes a first car and a second car in an elevator shaft, wherein the first car is moved with reference to a travel curve, wherein the first car is traveling or is configured to travel in a direction of the second car, wherein an adjustable minimum distance is maintained between the first car and the second car, wherein the first car is moved with reference to the travel curve such that a distance between the first car and the second car is controlled when moving the first car to the adjustable minimum distance so that the first car can approach the adjustable minimum distance from the second car.

28. An elevator installation comprising:
a first car that is movable in a shaft;
a second car that is movable in the shaft; and
a control system that causes the first car to move with reference to a travel curve, wherein the first car travels or is configured to travel in a direction of the second car, wherein the control system maintains an adjustable minimum distance between the first car and the second car, wherein the control system moves the first car with reference to the travel curve such that a distance between the first car and the second car is controlled when moving the first car to the adjustable minimum distance so that the first car can approach the adjustable minimum distance from the second car.
